(19) United States
(12) Patent Application Publication
(10) Pub. No.: US 2021/0049926 A1
(43) Pub. Date: Feb. 18, 2021

(54) INTEGRAL VISUAL LEARNING SYSTEM FOR THE ELECTRIC GUITAR AND SIMILAR INSTRUMENTS

(71) Applicant: Eric Damián ARELLANO NAVA, Ciudad de Mexico (MX)

(72) Inventor: Eric Damián ARELLANO NAVA, Ciudad de Mexico (MX)

(21) Appl. No.: 16/964,987

(22) PCT Filed: Jan. 26, 2018
(86) PCT No.: PCT/MX2018/000006

§ 371 Date: Jul. 26, 2020

(51) Int. Cl. G09B 15/00; G06F 3/16; G10H 3/18; G09G 3/32; G10H 1/00; G10H 3/14; G09G 5/377; G02B 27/01; G09B 15/02

(52) U.S. Cl. CPC G09B 15/003; G02B 2027/0141; G10H 3/181; G10H 3/188; G09G 3/32; G10H 1/0008; G10H 3/143; G09G 5/377; G02B 27/0172; G09B 15/023; G10H 2220/525; G10H 2210/091; G10H 2210/066; G09G 2354/00; G02B 2027/0178; G06F 3/167

(57) ABSTRACT

In summary, the integral visual learning system for electric guitar and similar instruments, to which the present invention refers, has a learning method that is integrated into an application for mobile devices and contains all the learning methodology and knowledge that It will be transmitted to the user to develop the ability to play the instrument. This learning method is connected to a display device on the instrument fretboard by means of a Bluetooth communication device and allows the user to visualize by means of the illumination of transparent resins, the information of notes, chords, musical scales, and other information sent from the learning method. The system also has an augmented reality device that is made up of augmented reality glasses that allow the user to visualize a virtual teacher who provides the user with theoretical information, as well as images superimposed with the position and shape of the fingers of your left/right hand to correctly play the notes, chords and musical scales. Likewise, the system has a feedback device that identifies the notes and/or chords that the user played on the instrument and compares them with the notes and/or chords requested in the exercises contained in the learning method, this allows the users identify the precision with which they performed the exercises and gradually improve until they obtain the required mastery at the different learning levels. Finally, the system has a recharge device for a lithium ion battery that powers the entire system.

Integrated visual learning system for electric guitar and similar instruments, to which the present invention refers, is within the field of musical instruments.

The integrated visual learning systems consist of; a) an integrated learning method in a mobile application b) a display device on the instrument fretboard c) an augmented reality device d) a feedback device, and finally e) a Bluetooth communication device and a battery recharging device.

The learning method is integrated in an application for mobile devices and contains the learning methodology and the knowledge that will be transmitted to the user to develop the ability to play the instrument. The display device on the instrument fretboard allows the user to view the information sent by means of the learning method using transparent resins. The augmented reality device is made up of augmented reality glasses that allow the user to be shown a virtual teacher as well as superimposed images that are sent by the learning method and finally the feedback device evaluates the precision with which the user executes the exercises given in the learning method.

The learning method, the display device on the instrument fretboard, the augmented reality device and the feedback device are connected by means of the Bluetooth communication device and together and combined form an integral visual learning system, which allows the user send from the mobile application the information of; notes, chords, scales and other knowledge necessary for learning the instrument, this information is displayed on the display device on the instrument fretboard so the user can identify where the notes are located and simultaneously the augmented reality device shows the user a virtual teacher and images with the position and shape of the fingers of his left/right hand to play the notes, chords and musical scales correctly and finally the feedback device identifies the notes/chords that the user played on the instrument and compares them with the notes/chord requested in the exercises contained in the learning method, to obtain the precision with which the user performed the exercises and guarantee that gradually improves until obtaining the required mastery at the different learning levels (FIG. 7). Finally, the system has a recharging device for a lithium ion battery, that powers the entire system.

### BACKGROUND OF THE INVENTION

Currently, the learning process of a musical instrument such as the electric guitar and similar instruments is mainly based on the transmission of knowledge through teachers or, where appropriate, through books and methods that help develop the ability to play the instrument.

Noting that there is a digital evolution in many aspects of our daily lives, it was thought to develop an integral visual learning system for electric guitar and similar instruments. This system allows the user to accelerate the practical and theoretical learning to play the instrument, since it reduces the time for memorization and learning of notes, chords, musical scales and other theoretical information necessary to play the instrument, and this consequently promotes the process of self-taught learning.

Currently, some patent applications for devices that perform some specific function that could be related to the present invention are found in the state of the art, but are differentiated by the following:
Patent application/Publication number U.S. Pat. No. 9,208,763B2 which refers to a device that provide feedback to the user by means of sensors that detect the force with which the strings are pressed and combined with a camera detects the position of the finger that touched the string to generate a comparison. The main difference of the present invention lies in that it is an integral system that combines various elements or devices that together guarantee user learning. On the other hand, the operation of the feedback device of the present invention is based on detecting the frequency and time of the note or notes that are executed by the user and comparing them with the practical exercises requested from the learning method contained in an application for mobile devices and with this to have an evaluation of the user when performing the exercises.
Patent application/Publication number U.S. Pat. No. 9,679,548B1 that refers to a flexible electronic display that is attached to an electronic device that is bent in the form of an arc, this device contains a camera that detects movement and allows mapping the movement of the external strings corresponding to virtual strings and generates as output the movement of the virtual strings to produce a sound. As in the previous case, the present invention differs from this application, in that it is an integral system that combines various elements or devices and which aims to show the user all the necessary information (from beginner to master level) to develop the ability to play the instrument, the application mentioned in this paragraph aims to identify movement to generate sounds.
Patent application/Publication number US20170125000A1 which refers to a method for controlling electronic string instruments, such as electronic midi guitars, video game guitars, and tablets representing virtual guitars. Similarly, the present invention differs from this application in that it is an integral system that combines several elements or devices. Some of the additional elements that the present invention has versus this application are, for example; a feedback device that allows evaluating the quality and precision of the user's execution, an augmented reality device that allows the user to show a virtual teacher and images superimposed with the instrument to position correctly the fingers of the hands and an integrated learning method in an application that contains the knowledge and practical exercises that the user must develop to obtain the ability to play the instrument correctly. Another important difference is that the method of the aforementioned application (US20170125000A1) focuses on teaching the chords of a song, while the method of the integral visual learning system for electric guitar and similar instruments referred to in this invention focuses on providing comprehensive knowledge segmented into four learning levels (beginner, intermediate, advanced and master) and containing practical and theoretical learning techniques, integrating the information of musical notes, triads, chords, scales, musical modes, harmony, melody, improvisation and practical exercises for each of the sections and subsections that are evaluated by the feedback device.

### BRIEF DESCRIPTION OF THE DRAWINGS

FIG. 1—Display device on the instrument fretboard—Assembly view

FIG. 2—Matrix of transparent or colored resins embedded in the fretboard of the instrument—Top view, left side view and isometric view.

FIG. 3—Microcontroller and light emitting diode matrix—Top view and isometric view.

FIG. 4—Bluetooth communication device, feedback device and a battery recharging device—Isometric view.

FIG. 5—Bluetooth communication device assembly, feedback device, battery recharging device whit instrument body—Isometric view.

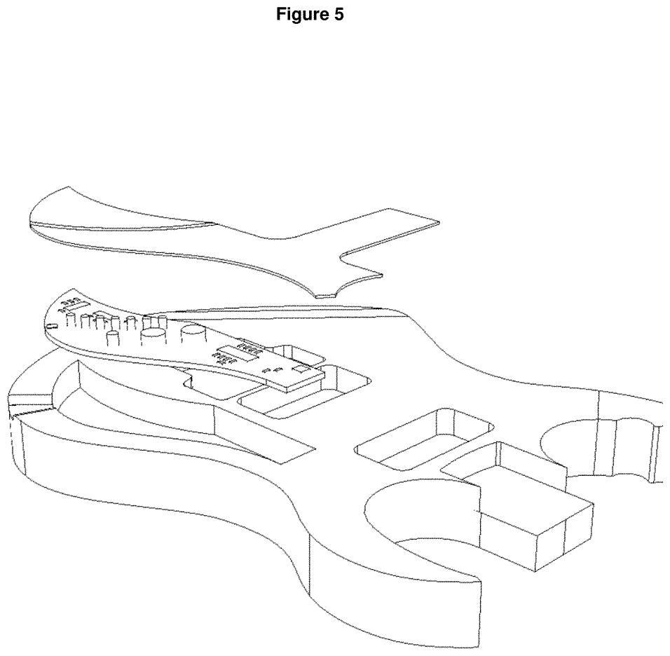

FIG. 6—Display device on the instrument fretboard example, to indicate the formation of a chord and a musical scale, with an instruction from the learning method.

FIG. 7—Elements of the integral visual learning system for the electric guitar and similar instruments. Example of interaction of all devices (display device on the instrument fretboard, augmented reality device, feedback device and integrated learning method in a mobile application).

### DETAILED DESCRIPTION

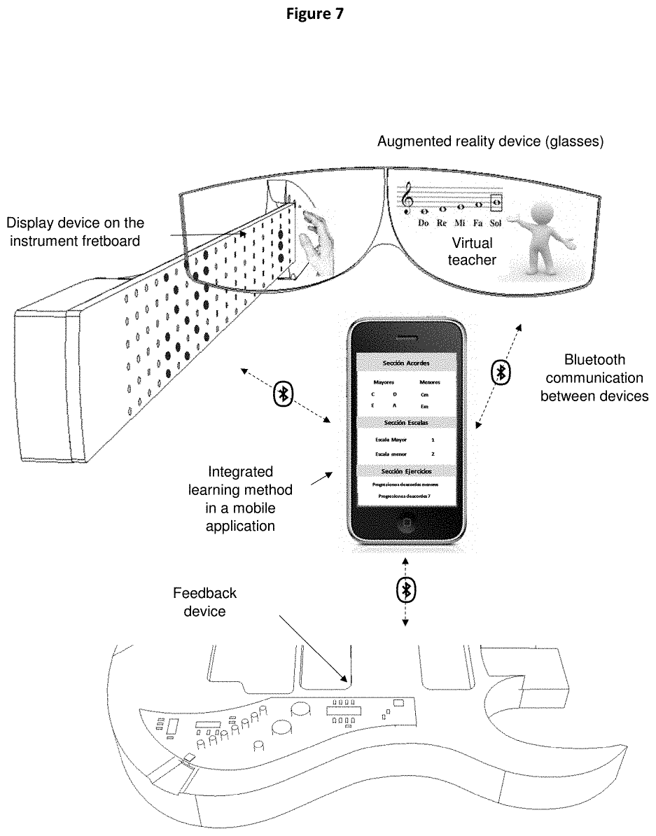

The integral visual learning system for electric guitar and similar instruments to which the present invention refers consists of: a) a learning method integrated into an application for mobile devices, b) a display device on the instrument fretboard, c) an augmented reality device d) a feedback device and finally e) a Bluetooth communication device and a battery recharging device (FIG. 7).

The learning method integrated in an application for mobile devices contains all the theoretical and practical information that the user will obtain through different learning levels (beginner, intermediate, advanced and master). The main element of the learning method is to facilitate the users the visualization process, by visually showing them the information of notes, chords, scales and other information necessary for learning the instrument (through the display device on the instrument fretboard and augmented reality device). The next element of the learning method is the theoretical and practical exercises found in each of the 4 learning levels, in which the user receives theoretical information on each of the topics so that they can subsequently carry out the practical execution of the exercises. which in turn are evaluated by the feedback device. The learning method will require the user to complete a minimum of hours of practice and precision in order to unlock the following levels. The type of practical exercises contained in the method can be, for example:
Execution and repetition of notes in different parts of the fretboard.
Execution and repetition of chords and chord sequences.
Execution and repetition of scales in different parts of the instrument fretboard, for example; major scale, minor scale, pentatonic scale, melodic minor scale, etc.
Execution and repetition of fragments of scales in two, three or four strings, descending, ascending, left-right, right-left, etc.
Execution and repetition of different techniques or ways of playing the instrument, for example; alternate picking, sweep picking, tapping, etc.
Playback of music tracks on which the user can perform improvisation exercises with scales.

Additionally, the learning method integrated in an application for mobile devices allows the users to view a virtual teacher through the augmented reality device that guides them through the different lessons and exercises.

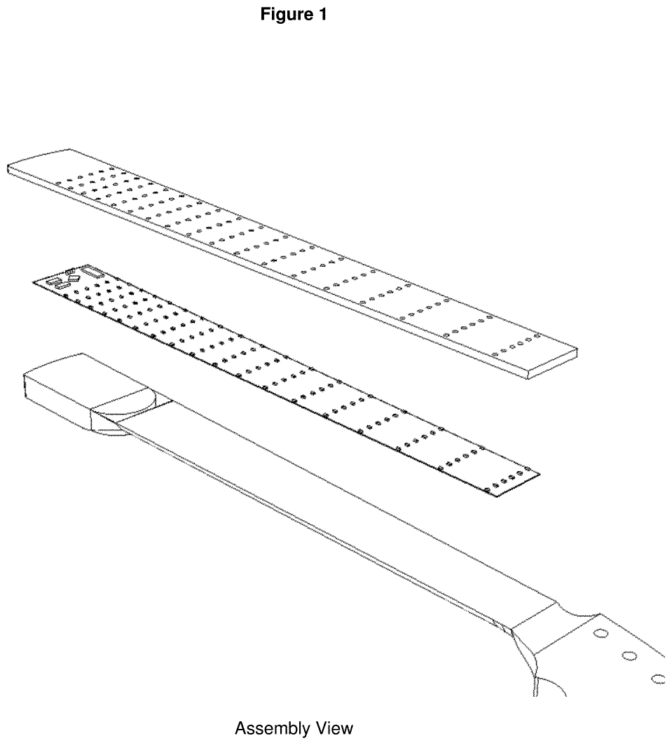

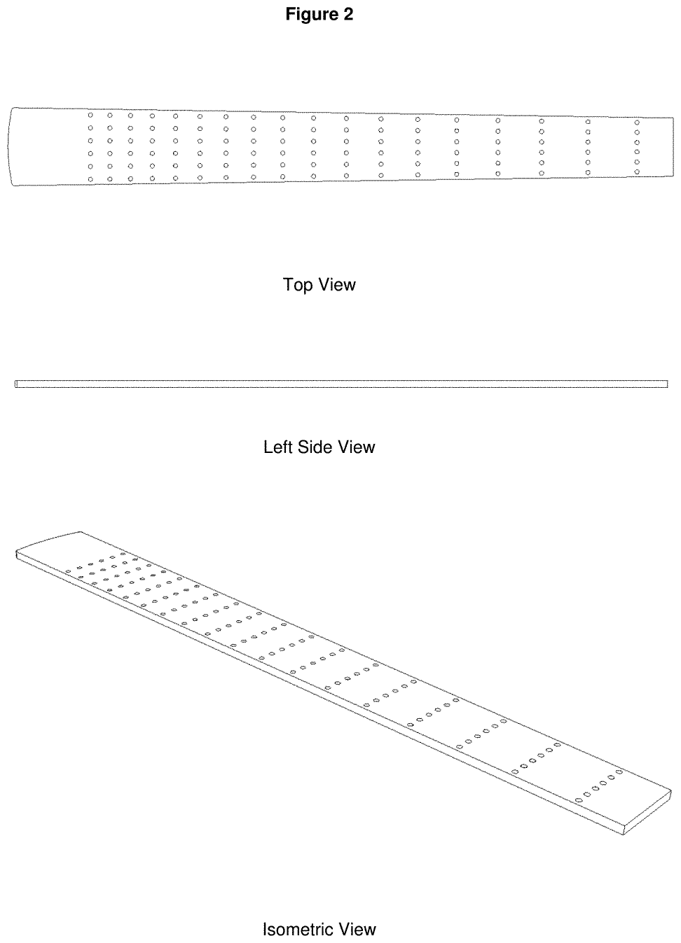

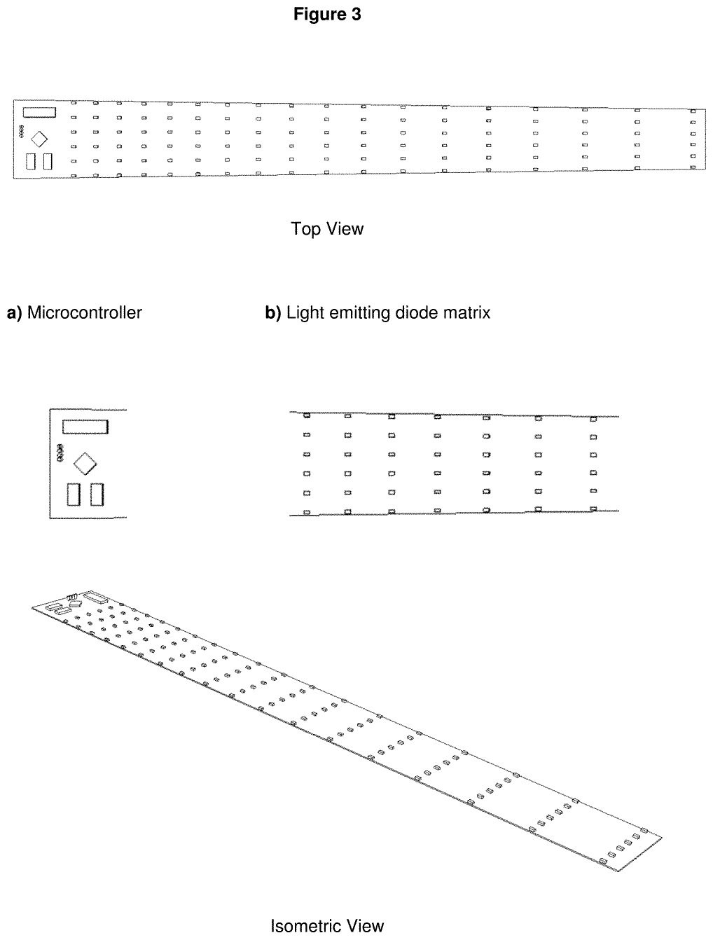

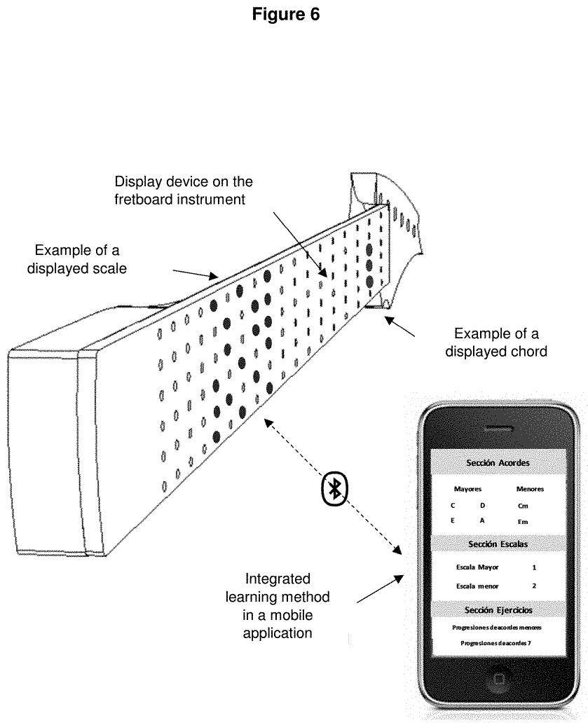

The display device on the instrument fretboard (FIG. 1 and FIG. 6) is composed of the following elements a) a microcontroller and auxiliary components b) a matrix of light emitting diodes and c) a matrix of transparent resins. The microcontroller (FIG. 3a) is connected by means of the Bluetooth communication device to the application that contains the learning method, said microcontroller has an embedded program whose function is to receive the instructions sent by the learning method and translate them, so that the information sent by the method, is displayed in the matrix of light-emitting diodes that is inside the instrument fretboard (FIG. 3b and FIG. 1) and this in turn illuminates the matrix of transparent resins (FIG. 2), this last matrix is placed at each of the intersections of each fret of the instrument with each of the strings of the instrument along 18 frets. In this way, the display device on the instrument fretboard, allows the users to visually see the information necessary for learning the instrument, such as; notes, chords, musical scales, etc.
The matrix of transparent display resins are produced with methods known in the art in the following manner; Perforations are made in the fretboard of the instrument, with drill-type tools or numerical control machines in each of the fret vs. string intersections, then a transparent or colored liquid resin that hardens after 24 hours is placed and finally it is carried out a process of sanding and polishing the surface in such a way that the instrument arm (fretboard) is flat, but with the display resins inserted.
The microcontroller and the matrix of light emitting diodes are mounted on a PCB (Printed Circuit Board) and is produced by methods and procedures known in the art as follows; first the diagram or schematics are designed with the electronic elements necessary for the desired operation, then the circuit is printed on PCB cards where the electronic components are assembled and soldered according to the electrical diagram designed to perform the function defined for each device.

The augmented reality device (FIG. 7) is made up of augmented reality glasses that are connected by means of the Bluetooth communication device to the application for mobile devices that contains the learning method and through which the instructions are sent and that unfold in augmented reality glasses. The augmented reality device allows the user to visualize a virtual teacher who provides theoretical information, as well as overlapping images with the instrument fretboard that align with the visual patterns shown by the display device on the instrument fretboard, to show the user how to position the fingers of the hand on the instrument fretboard and thus correctly play notes, form chords, musical scales and other knowledge necessary to learn to play the instrument (FIG. 6 and FIG. 7).
The augmented reality device is produced with methods known in the art that are distributed by companies such as; Google, Epson (TEXA), Meta (Meta2), Apple (iGlass), as well as various softwares that allow you to program augmented reality systems; Argon (Augmented Reality Browser) ARToolKit (Augmented Reality Apps), ArUco (Augmented Reality Apps), Goblin XNA (30 user intefaces platform), Mixare (mix Augmented Reality Engine), DroidAR (Augmented Reality Framework for Android), etc.

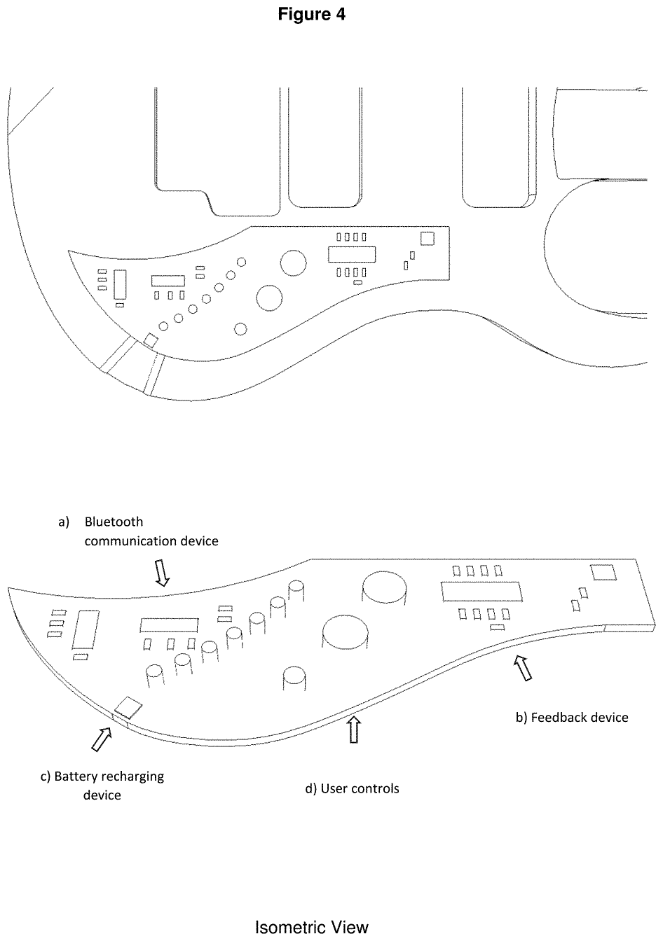

The feedback device (FIG. 4b and FIG. 7) has as a function to recognize the frequency of the notes produced by the piezoelectric pickups to compare them with a database where the frequencies of all the notes and chords are defined and thus identify the note or notes that were played by the user. Piezoelectric pickups known in the art, are incorporated in instruments such as electric guitars, electro-acoustic guitars, electric basses and have the function of converting the mechanical waves produced by the vibration of the strings, into electrical signals with a certain frequency, said signal is used as input for the feedback device, which is connected by means of the Bluetooth communication device to the application that contains the learning method and in this way the feedback device can send the application the information of the notes that were executed by the user (precision and execution time) in order for the users to receive, through the application, feedback on their precision with which they executed the practical exercises established in the method and that this will allow them to improve the performance of their exercises and accumulate hours of practice to be able unlock the next levels.
The feedback device is mounted on a PCB (Printed Circuit Board) and is produced by methods and procedures known in the art as follows; first the diagram or schematics are designed with the electronic elements necessary for the desired operation, subsequently, the circuit is printed on PCB cards where the electronic components are assembled and soldered according to the electrical diagram designed to perform the function defined for each device.

The Bluetooth communication device, (FIG. 4a) has a low-energy Bluetooth module and auxiliary components, which allows establishing communication to receive and send data between the display device on the instrument fretboard, the feedback device, the augmented reality device and the application for mobile devices that contains the learning method and finally the integral visual learning system for guitars and similar instruments has a charger device, (FIG. 4c) that contains a micro USB type connector to connect a USB type charger to the electrical current that recharges a rechargeable lithium ion battery, which in turn powers all the devices mentioned above that are incorporated inside the guitar or similar instrument.
The Bluetooth communication and charger devices are mounted on a PCB (Printed Circuit Board) and are produced by methods and procedures known in the art as follows; first the diagram or schematics are designed with the electronic elements necessary for the desired operation, then the circuit is printed on PCB cards where the electronic components are assembled and soldered according to the electrical diagram designed to perform the function defined for each device.

In conclusion, the integral visual learning system for electric guitar and similar instruments to which the present invention refers, provides the users with a system to develop the ability to play the instrument in an accelerated and self-taught way, due to the facts that the users learn with a system that allows them to visualization notes, chords, musical scales, all the theoretical information and content is organized in different levels of learning, they receive real-time feedback and performance evaluation and all this through a digital, modern and fun concept for the users.

Having described the invention as above, the content of the following claims is requested as property.

1. An integral visual learning system for electric guitar and similar instruments, which incorporates elements that are currently in the state of the art such as; Bluetooth communication modules, microcontrollers, electronic components, light emitting diode matrix, augmented reality glasses and mobile devices, and characterized by:
a) a learning method integrated in an application for mobile devices that contains the methodology and knowledge that will be transmitted to the user to develop the ability to play the instrument,
b) a display device on the instrument fretboard that is composed of; a microcontroller and auxiliary components, a matrix of emitting diodes that is incorporated inside the instrument fretboard and that illuminate a matrix of transparent resins placed on each fret and strings of the instrument fretboard,
c) an augmented reality device that is made up of augmented reality glasses that allow the user to be shown a virtual teacher, theoretical information and superimposed images,
d) a feedback device whose function is to identify the notes and chords played by the user to compare with the exercises requested from the learning method and with this, to evaluate the precision and progress of the user.
e) a Bluetooth communication device that allows communication to be established between the application that contains the learning method, the display device on the instrument fretboard, the augmented reality device and the feedback device,
f) a battery recharging device that powers of all the aforementioned systems and gives mobility to the user,
g) It is also characterized by the fact that the method integrated in the application, the display device on the instrument fretboard, the augmented reality device and the feedback device are connected by means of the Bluetooth communication device and together and combined they form an integral system of visual learning, that allows the users to send from the mobile application the information of notes, chords, scales and other knowledge necessary for learning the instrument and such information is displayed on the display device on the instrument fretboard for the users to identify where notes are found and simultaneously the augmented reality device shows the users a virtual teacher who provides theoretical information and also images of the position and shape of the fingers of his left/right hand to correctly play the notes, chords and scales, finally the feedback device identifies the notes, chords and musical scales that the users performed on the instrument and compares them with the musical notes, chords and scales requested in the exercises contained in the learning method, to obtain the precision with which the user executed the exercises and guarantee to gradually improve practical execution until obtaining the required mastery at different levels of learning. Altogether this integral visual learning system for electric guitar and similar instruments allows the user to achieve accelerated learning vs. traditional methods.
h) and finally, it is characterized by the fact it is implemented in electric guitars and similar instruments.

2. A learning method integrated into an application for mobile devices and characterized by:
a) contain all the theoretical and practical information for the users at different levels of learning, which are; beginner, intermediate, advanced and master, each of the learning levels are divided into 3 or more sublevels. In each sublevel the user will be able to obtain and accumulate points by carrying out the practical exercises established in each sublevel, the greater the precision in the execution of the exercises, the greater the number of points obtained, said practical exercises are evaluated by means of the feedback device that is described in claim 5. The user can unlock the following levels at the time he accumulates the number of points necessary to guarantee the acquisition of knowledge in each learning sub-level.
b) have a virtual teacher that the users can observe through the augmented reality device described in claim 4, which provides the users with theoretical information on each of the sublevels, as well as visual information on the correct positioning of the fingers left/right hand to play notes, chords, scales, practical exercises and other knowledge necessary to learn the instrument.
c) have theoretical and practical learning techniques, where the users receive theoretical information on each of the topics and subsequently performs practices by executing the following types of exercises:
Playing and repeating notes in different parts of the fretboard.
Execution and repetition of chords and chord sequences.
Execution and repetition of scales in different forms of the instrument fretboard. Example; major scale, minor scale, pentatonic scale, melodic minor scale, etc.
Execution and repetition of fragments of scales in two, three or four strings, descending, ascending, left-right, right-left, etc.
Execution and repetition of different techniques or ways of playing the instrument, example: alternate picking, sweep picking, tapping, etc.
Playing music tracks on which, the users can perform song exercises, chord sequences, improvisation with scales, etc.
Exercises with a metronome incorporated in the application and exercises with drum tracks at different speeds.
d) have a Bluetooth communication protocol that allows the users to connect to the display device on the instrument fretboard and send character codes, which are interpreted by the display device on the instrument fretboard to display by of the illumination of the matrix of transparent resins the location of the notes, chords, scales and other information. In each of the method's sublevels, the user will be able to select; buttons or commands that display theoretical information to the user directly in the application, buttons or commands that send information to the display device on the instrument fretboard, and buttons or commands that send information to the augmented reality system.
e) have the voice recognition functionality, which allows the user to interact with the application by voice, in order to advance within the method and be able to carry out practical exercises while keeping their hands on the instrument.
f) have the functionality of being able to personalize the progress of each of the users, registering in an internet database the progress information of each of the users in order to provide periodic feedback to each of the users on their performance, reminders so that they can track their learning on the instrument and recommendations for specific exercises according to their level and musical styles.
g) and finally, it is characterized by the fact it is implemented in claim number 1.

3. A display device on the instrument fretboard characterized by:
a) have a matrix of transparent or colored resins that are placed in each of the intersections of; each fret of the instrument, with each of the instrument strings along 18 frets, said resins are illuminated to show the users the information that is sent by the method of learning described in claim 2, the resins are located at the top of the fretboard in the users view.
b) have a matrix of light emitting diodes, which are mounted on a PCB (Printed Circuit Board) which in turn is incorporated inside the instrument fretboard. Said matrix of light emitting diodes has the same alignment and coincidence with the matrix of transparent resins and it is positioned just below the resin matrix, so that when any of the light emitting diodes light up, the light is projected onto the resin that is on top and is also shown illuminated.
c) have a microcontroller and auxiliary electronic components that are mounted on the same PCB (Printed Circuit Board) where the matrix of light-emitting diodes is mounted. Said microcontroller contains an embedded program that is responsible for interpreting the character code sent by the learning method described in claim 2 and translating it to send it to the matrix of light-emitting diodes in such a way that the diodes light up, according to the specific sequences or patterns sent from the learning method. The microcontroller is connected to the Bluetooth communication device for sending and receiving information.
c) and finally, it is characterized by the fact it is implemented in claim number 1.

4. An augmented reality device characterized by:
a) having augmented reality glasses that allow the user to be shown to a virtual teacher who provides them with theoretical information and also images of the position and shape of the fingers of their left/right hand to correctly play the notes, chords and scales and other information necessary for learning the instrument. The images seen in augmented reality glasses are images overlaid with the instrument fretboard, and are aligned with the visual patterns that are shown by the display device on the instrument fretboard described in claim 3, such that when the display device shows a specific chord, augmented reality glasses will detect that chord and they will show a superimposed image with the way the left hand should plays the chord. The augmented reality device is connected to the learning method content in the mobile application through the Bluetooth communication device.
b) and finally, it is characterized by the fact it is implemented in claim number 1.

5. A feedback device characterized by:
a) having piezoelectric or electromechanical pickups whose function is to convert the movement produced by the strings of the instrument when touched, into small electrical signals. The pickups are made of a permanent magnet surrounded by a copper wire winding, when the instrument strings having an iron or nickel core move within the magnetic field of the permanent magnet, an induced electric current is caused in the winding, proportional to the amplitude of movement and frequency equal to that of the oscillation of the moving string, the electrical signal obtained from the pickups is an analog signal.
b) it is also characterized by having an electronic circuit whose function is: to process the analog signal obtained in the piezoelectric or electromechanical pickups to convert it into a digital or square signal that will serve as an input to the microcontroller for its interpretation. Processing is done by amplifying the signal, eliminating noise and interferences, moving the reference point of the signal and eliminating negative values so that the digital signal can finally be obtained.
c) It is also characterized by having a microcontroller and auxiliary electronic components whose function is to determine the frequency of the digital signal and compare it with a frequency data bank that contains the frequency of each of the notes and the possible combinations of notes. This process is carried out by means of a program embedded within the microcontroller that contains the mathematical functions that transform the function of the signal that is in the time domain to the frequency domain and with this determine the frequency of the signal, once that the signal frequency has been determined, it is compared in the frequency data bank contained in the memory of the microcontroller, to determine which note or notes were played on the instrument and its duration, the microcontroller sends this information to the application by means of the Bluetooth communication device, so that the learning method compares vs. the exercises that were requested to be performed. This last step allows the learning method to identify if the user performed the exercises with the precision that the learning method requested and to establish a score for each of the exercises. b) and finally, it is characterized by the fact it is implemented in claim number 1.
